(19) United States
(12) Patent Application Publication
(10) Pub. No.: US 2007/0277870 A1
(43) Pub. Date: Dec. 6, 2007

(54) SOLAR HYDROGEN GENERATION SYSTEM

(76) Inventor: Mark Wechsler, San Mateo, CA (US)

Correspondence Address: STEVEN VOSEN, 1563 SOLANO AVENUE #206, BERKELEY, CA, 94707, US

(21) Appl. No.: 11/421,416

(22) Filed: May 31, 2006

(51) Int. Cl. H02N 6/00

(52) U.S. Cl. 136/248

(57) ABSTRACT

A solar hydrogen generation system is disclosed that efficiently utilizes photovoltaic cells, storage batteries, and electrolyzers to generate hydrogen from the sun by direct coupling of these components. The system mutually arranges the photovoltaic cells, batteries, and electrolyzers in series, and the series components in parallel. The arrangement allows the voltages of the photovoltaic cells, batteries, and electrolyzers to match each other for optimal performance. The invention further provides for continuous hydrogen generation, even through the night or periods of low solar flux, and a system for preventing the overcharging of the batteries.

### BACKGROUND OF THE INVENTION

1. Field of the Invention

The present invention generally relates to systems for generating hydrogen using solar energy, and more particularly to apparatus and methods for generating hydrogen using solar energy.

2. Discussion of the Background

As the world's oil reserves are diminishing and energy demand increases, there is an ongoing effort to develop alternative energy sources. Hydrogen plays a key role in that it is an energy carrier that can be generated using many different methods including, but not limited to, reforming of hydrocarbon fuels, such as by steam reforming, biological activity using specially tailored microorganisms, and the electrolyzing of water. Electrolysis is an electrically driven process that liberates the hydrogen stored in water. The electricity for electrolysis typically comes from conventionally obtained, grid power.

An alternative method of producing hydrogen is through a solar electric driven electrolysis process. While the use of photovoltaic (PV) generated electric power to generate hydrogen is environmentally attractive, this method of producing hydrogen has several problems. Typically, prior art hydrogen generation systems include PV to generate electricity and an electrolyzer to accept power from the PV and generate hydrogen. Generally, the electrical characteristics of the PV and electrolyzer are not optimally matched, resulting in either the less-than-optimal use of PV and electrolyzer, or the use of expensive power conditioning devices between the PV and electrolyzer. In addition, some prior art hydrogen generation system operate the electrolyzers in an unsteady mode, following the solar input, preventing the electrolyzer from obtaining optimal, steady state operation.

Thus there is a need in the art for a method and apparatus that permits for production of hydrogen using solar energy. Such a method and apparatus should be electrically simple and maintenance free, cost effective, and efficient.

### BRIEF SUMMARY OF THE INVENTION

The present invention overcomes the limitations and problems of the prior art using PV, storage batteries, and electrolyzers in a system that efficiently operates each component at high efficiency. For example, one embodiment of the invention mutually arranges the PV, storage batteries, and electrolyzers in series, and connects the series components in parallel. This permits the electrical arrangement of the PV, storage batteries, and electrolyzers in a manner that matches the voltages and performance of the individual components.

It is one aspect of the present invention to provide a solar energy device having electrical connections for powering an electrolyzer to electrolyze a water solution. The solar energy device includes one or more photovoltaic cells and one or more batteries. The one or more photovoltaic cells and the one or more batteries are in parallel with the electrical connections for powering an electrolyzer.

It is another aspect of the present invention to provide a solar energy device having electrical connections between one or more photovoltaic cells and one or more batteries for powering an electrolyzer to electrolyze a water solution, where the maximum potential of the one or more photovoltaic cells that is greater than the maximum potential of the one or more batteries. In one embodiment, the maximum potential of the one or more batteries is greater than the minimum potential required to electrolyze the water solution.

It is yet another aspect of the present invention to provide a solar energy device having electrical connections between one or more photovoltaic cells and one or more batteries for powering an electrolyzer to electrolyze a water solution, where each of the one or more batteries is a nickel iron batteries.

It is one aspect of the present invention to provide a solar energy device having electrical connections between one or more photovoltaic cells and one or more batteries for powering an electrolyzer to electrolyze a water solution, where each of the one or more photovoltaic cells is a silicon solar cell.

It is another aspect of the present invention to provide a solar-powered electrolyzer to electrolyze a water solution. The solar-powered electrolyzer includes one or more photovoltaic cells, one or more batteries, and one or more electrolyzers. The one or more photovoltaic cells and the one or more batteries are in parallel with the one or more electrolyzers. In one embodiment, the maximum potential of the one or more photovoltaic cells is greater than the maximum potential of the one or more batteries. In another embodiment, the maximum potential of the one or more batteries is greater than the minimum potential required to electrolyze the water solution. In another embodiment, when the one or more photovoltaic cells are exposed to a diurnal solar flux, the one or more photovoltaic cells and the one or more batteries have electrical characteristics to permit the continuous operation of the one or more electrolyzer cells. In yet another embodiment, the electrical characteristics are selected to permit the continuous operation of the one or more electrolyzer cells when the one or more photovoltaic cells are exposed to no solar flux for up to four days.

It is yet another aspect of the invention to provide a device for producing hydrogen from a flux of solar energy comprising one or more photovoltaic cells, one or more batteries, one or more electrolyzers electrically connected to the one or more photovoltaic cells and the one or more batteries, and a mechanism for modifying the amount of solar energy impinging on the one or more photovoltaic cells. In one embodiment, the mechanism prevents the one or more batteries from overcharging. In another embodiment, the mechanism moves the orientation of the one or more photovoltaic cells relative to the horizon.

These features together with the various ancillary provisions and features which will become apparent to those skilled in the art from the following detailed description, are attained by the exercise device of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a schematic of a solar hydrogen generation system of the present invention;

FIGS. 2A, 2B, and 2C are schematics of a first embodiment solar hydrogen generation system, where FIG. 2A is a schematic side view of the solar hydrogen generation system, FIG. 2B is a schematic side view of the system, and FIG. 2C is a schematic wiring diagram of the system;

FIG. 3 is a schematic of a second embodiment solar hydrogen generation system;

FIG. 4 is a schematic of a third embodiment solar hydrogen generation system;

FIGS. 5A-5C are schematic circuit diagrams illustrating the wiring of various embodiments of the photovoltaic module, where FIG. 5A illustrates the photovoltaic module with one PV device, FIG. 5B illustrates the photovoltaic module with 2 PV devices in series, and FIG. 5C illustrates the photovoltaic module with a number “n” of PV devices in series;

FIGS. 6A-6C are schematic circuit diagrams illustrating the wiring of various embodiments of the electric energy storage module, where FIG. 6A illustrates the electric energy storage module with one reversible battery, FIG. 6B illustrates the electric energy storage module with two reversible batteries in series, and FIG. 6C illustrates the electric energy storage module with a number “n” of reversible batteries in series;

FIGS. 7A-7C are schematic circuit diagrams illustrating the wiring of various embodiments of the electrolyzer module, where FIG. 7A illustrates the electrolyzer module with one electrolyzer, FIG. 7B illustrates the electrolyzer module with two electrolyzers in series, and FIG. 7C illustrates the electrolyzer module with a number “n” of electrolyzers in series;

FIG. 8 is a schematic wiring diagram of one module of the present invention;

FIG. 9 is a graph of the voltage-current characteristics for a PV cell under different amounts of illumination;

FIG. 10 is a graph of the voltage-power characteristics for a PV cell under different amounts of illumination;

FIG. 11 is a graph of the voltage-SOC characteristics for a NiFe battery;

FIG. 12 is a graph of the voltage-current characteristics for an electrolyzer;

FIG. 13 is a graph of the voltage-efficiency characteristics for an electrolyzer;

FIG. 14 is a schematic circuit diagram of a photovoltaic module/electric energy storage module combination; and

FIG. 15 is a schematic circuit diagram of an electric energy storage module/electrolyzer combination.

Reference symbols are used in the Figures to indicate certain components, aspects or features shown therein, with reference symbols common to more than one Figure indicating like components, aspects or features shown therein.

### DETAILED DESCRIPTION OF THE INVENTION

The invention will now be described in terms of a solar hydrogen generating system and components thereof for efficiently converting sunlight to hydrogen. Although certain preferred embodiments and examples are disclosed below, it will be understood by those skilled in the art that the inventive subject matter extends beyond the specifically disclosed embodiments to other alternative embodiments and/or uses of the invention and obvious modifications and equivalents thereof. Thus it is intended that the scope of the inventions herein disclosed should not be limited by the particular disclosed embodiments described below. For purposes of contrasting various embodiments with the prior art, certain aspects and advantages of these embodiments are described where appropriate herein. Of course, it is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

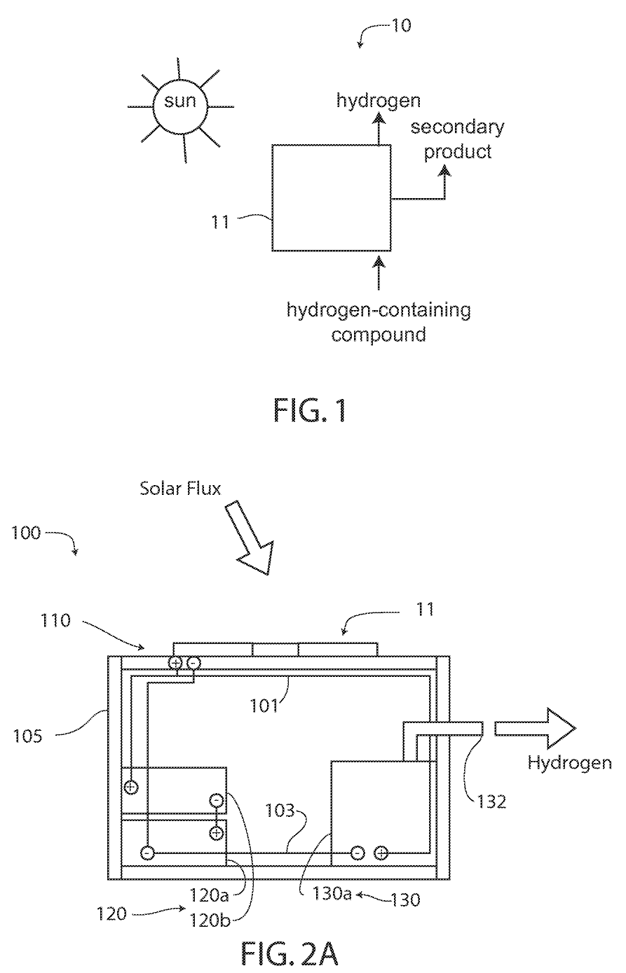

FIG. 1 is a schematic illustration of the one embodiment solar hydrogen generation system 10 of the present invention. System 10 has a solar-flux accepting surface 11 that accepts power in the form of electromagnetic radiation from the sun. The accepted power is used to covert a hydrogen-containing compound into a stream of hydrogen and a secondary product. In one embodiment that does not limit the scope of the present invention, the hydrogen-containing compound includes water, and the secondary product includes oxygen.

More specifically, system 10 includes photovoltaic (“PV”) cells and one or more rechargeable batteries that are connected to an electrolyzer, as described, for example, subsequently. The components of system 10 are sized, wired, and operated in a manner that permits generation of hydrogen at a nearly constant rate for prolonged periods of time, for example through a night or through days having little sunlight. System 10 may, in alternative embodiments, include devices to track the sun (that is, maximize or control the total flux impinging on surface 11), or an optical arrangement having a surface 11 that magnifies the flux onto the PV cells.

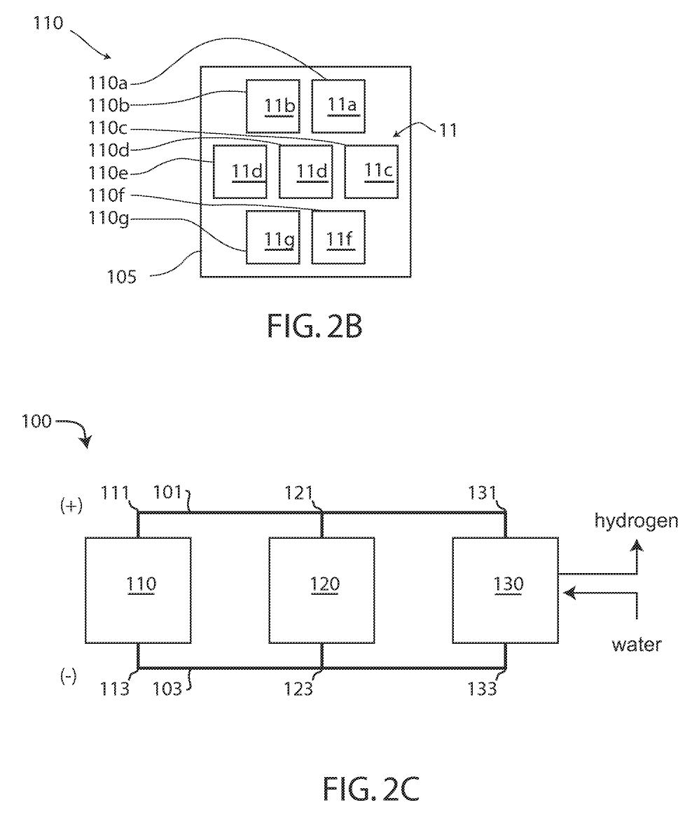

FIGS. 2A, 2B, and 2C are schematics of a first embodiment solar hydrogen generation system 100, where FIG. 2A is a schematic side view of the solar hydrogen generation system, FIG. 2B is a schematic side view of the system, and FIG. 2C is a schematic wiring diagram of the system. System 100 may be generally similar to the system 10.

System 100 includes a PV module 110, an electric energy storage module 120, and an electrolyzer module 130. As shown in FIG. 2A, modules 110, 120, and 130 are located on a frame 105. Alternatively, module 110 is located on frame 105 and modules 120 and 130 are located nearby.

PV module 110 includes, but is not limited to, one or more solar energy-to-electricity generating devices formed of bulk, thin film, multi-layered thin-film composites, polymers, or matrices thin-film photovoltaic materials in a conductive polymers or mesoporous metal oxide matrix, and referred to herein without limitation as “PV devices.” PV modules that may be used with the present invention may be obtained, for example, from Sunpower Corporation (Sunnyvale, Calif.). FIGS. 2A and 2B illustrate PV module 110, without limitation as to the present invention, as having seven PV devices (PV devices 110a, 110b, 110c, 110d, 110e, 110f, and 110g), arranged in an hexagonal pattern and each having a respective flux-accepting surface (surface 11a, 11b, 11c, 11d, 11e, 11f, and 11g) that form flux-accepting surface 11. In one embodiment, each PV device 110a, 110b, 110c, 110d, 110e, 110f, and 110g, includes a single PV cell.

In general, PV module 110 is formed from a single PV device or from two or more individual PV devices that are connected electrically, in serial, parallel, or in another arrangement, such as a combined serial-parallel arrangement, and have a positive terminal 111 and a negative terminal 113. PV module 110 is, in various embodiments of the invention, fixed or controllably positionable and may include concentrating optics to magnify the solar flux.

Electric energy storage module 120 includes one or more devices that reversibly store electric energy. These devices are referred to herein and without limitation as “rechargeable batteries.” FIG. 2A illustrates electric energy storage module 120, without limitation as to the present invention, as having two electric energy storage devices: electric energy storage devices 120a and 120b. Rechargeable batteries of the present invention include, but are not limited to, lead-acid, lithium ion, lithium ion polymer, NaS, nickel metal hydride, nickel-cadmium, nickel-iron (NiFe), sodium-metal chloride, and nickel-zinc batteries. NiFe batteries that may be used with the present invention may be obtained, for example, from Sichuan Changhong Battery Company Limited (Mianyang Sichuan, China). The rechargeable batteries of electric energy storage module 120 are connected electrically, in serial, parallel, or in another arrangement, such as a combined serial-parallel arrangement, and have a positive terminal 121 and a negative terminal 123.

Electrolyzer module 130 includes one or more devices, referred to herein and without limitation as “electrolyzers,” that accepts an electric current and liberates the hydrogen stored in a chemical compound. FIG. 2A illustrates electrolyzer module 130, without limitation as to the present invention, as having one electrolyzer device 130a. In one embodiment, the electrolyzers of electrolyzer module 130 convert water into hydrogen and oxygen. Examples of electrolyzers include, but are not limited to, alkaline electrolyzers (such as electrolyzers using KOH or other alkaline electrolytes) or fuel cell-like devices (such as those utilizing proton exchange membranes (PEM)). Electrolyzers that may be used with the present invention may be obtained, for example, from Hydrogenics Corporation (Mississauga, Ontario, Canada), Norsk Hydro ASA (Oslo, Norway), or Hydrogen Wind, Inc (Lineville, Iowa). The electrolyzers of electrolyzer module 130 are connected electrically, in serial, parallel, or in another arrangement, such as a combined serial-parallel arrangement, and have a positive terminal 131 and a negative terminal 133, and the electrolyzer supplies hydrogen through an outlet 132 for storage or use.

As is further shown in FIG. 2C, solar hydrogen generation system 100 includes a first conductor 101 and a second conductor 103. First conductor 101 connects positive terminals 111, 121, and 131, and a second conductor 103 connects negative terminals 113, 123, and 133, such that modules 110, 120, and 130 are connected in parallel.

As described subsequently, system 100 generates electric power in photovoltaic module 110 which is used in electrolyzer module 130 to generate hydrogen from water. Electric energy storage module 120 permits system 100 to generate hydrogen during periods of decreased sunlight by reversibly storing electric energy. In one embodiment, modules 110, 120, 130, as described subsequently, operate passively—that is, with no other power control or power conditioning elements between the modules. In another embodiment, modules 110, 120, 130 operate passively and include a tracking mechanism to control the operation according to the solar flux on solar-flux accepting surface 11.

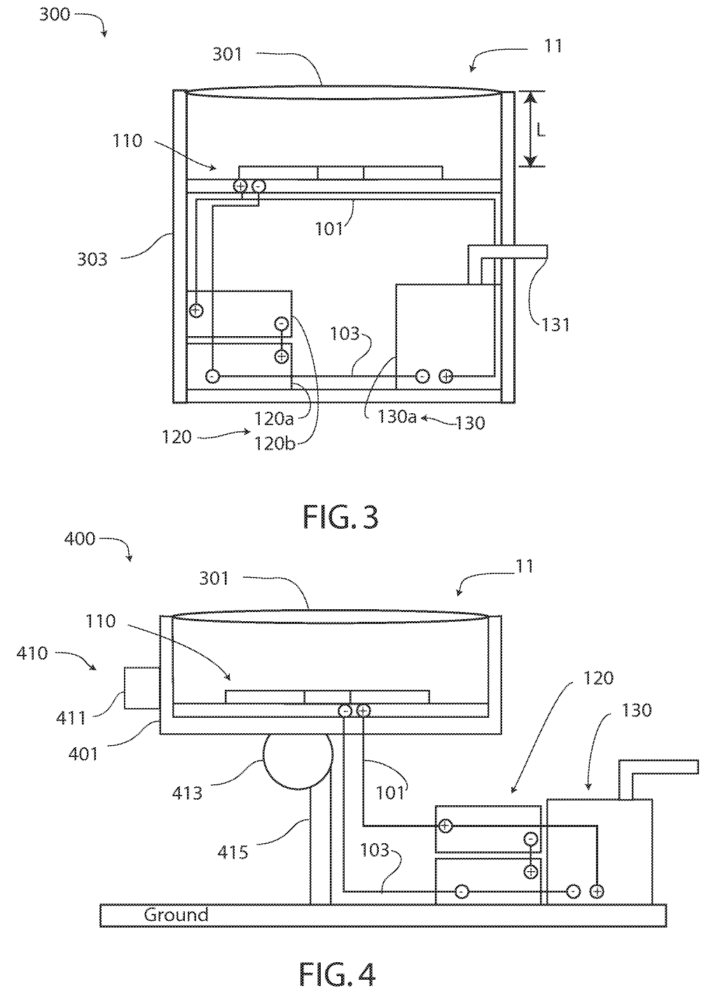

FIG. 3 is a schematic of a second embodiment solar hydrogen generation system 300, which may be generally similar to systems 10 or 100, except as described below.

System 300 includes magnifying optics—specifically a lens 301 positioned above PV module 110 using frame 303, which is otherwise similar to frame 105. The design on magnifying optics is well known in the field. As an example which is not meant to limit the scope of the present invention, if lens 301 has a focal length, f, and is positioned a distance, L, above PV module 110, then the magnification, M, is given by M=f/(f−L). This magnification is also referred to herein as the number of “suns”—that is a magnification of 2 is the equivalent to “2 suns” of flux. Alternatively, compound lenses or non-imaging optical devices are used to magnify the solar flux on PV module 110.

FIG. 4 is a schematic of a third embodiment solar hydrogen generation system 400, which may be generally similar to the systems 10, 100, or 300, except as described below.

System 400 includes a frame 401 on which PV module 110 is mounted and, alternatively, a lens 301. System 400 also includes a tracking system 410 that includes an electronic device 411 mounted on a frame 401, a motor/gimbal assembly 413, and a mounting post 415 that is mounted in the ground. Electric energy storage modules 120 and electrolyzer module 130 are located on the ground near mounting post 415. FIG. 4 also schematically shows the wiring of modules 110, 120, and 130.

The mounting of PV on trackers is well known in the art. Typically the PV is rotatably mounted to present surface 11 towards the sun by rotating system 400 using one or more motors. Thus, for example, photovoltaic module 110 is driven by motor/gimbal assembly 413 such that surface 11 is pointed towards the sun. By tracking the sun, the photovoltaic power output may be maximized throughout the day.

In one embodiment, tracking system 411 includes a light sensitive device and electrical connections to the motor of motor/gimbal assembly 413. Tracking system 411 provides controls to motor/gimbal assembly 413 that, in one embodiment, keeps flux-accepting surface 11 perpendicular to the suns rays.

In an alternative embodiment, tracking system 411 is electrically connected to one or more of modules 110, 120, and 130 to monitor the state of one or more modules. In one embodiment, tracking system 411 includes a processor that monitors the state of charge of electric energy storage module 120 and, if the energy storage module is nearing a fully charged state, moves surface 11 to a less than optimal orientation relative to the sun such that PV module 110 output is decreased to prevent overcharging the energy storage module. Thus, for example, the state of charge (SOC) of electric energy storage module 120 is monitored by tracking system 410. The SOC is for a specific embodiment is discussed subsequently. If the SOC is close to overcharging electric energy storage module 120, as indicated, for example, by a potential that is approaching the maximum potential of the battery, the tracking system is purposely controlled to not follow the sun, and thus not maximize the output of photovoltaic module 110. Controlling the tracking of photovoltaic module 110 can thus be used to prevent overcharging and damaging electric energy storage module 120.

At any time during the operation of system 100/300/400, modules 110, 120, and 130 may be characterized as follows. The open circuit potential across photovoltaic module 110 is Vpv, the potential difference across electric energy storage module 120 is Vb, and the potential across the electrolyzer module 130 is Ve. Modules 110, 120, and 130 are in parallel, and thus if perfectly matched:

Vpv=Vb=Ve. Eq. 1

In practical systems, there will be losses associated with each module and the interconnection between modules, and it may be difficult to precisely match the voltages for optimal operating conditions. In addition, it may be desirable to provide the electrolyzer or battery with a slightly higher driving potential. For this reason, the voltages may be selected to satisfy the following relationship:

Vpv≧Vb≧Ve. Eq. 2

In one embodiment, photovoltaic module 110 and electric energy storage module 120 are sized such that electrolyzer module 130 generates hydrogen at an approximately constant rate, even through daily variations of solar flux. Thus, for example, when the sun is shining, some of the energy from photovoltaic module 110 is stored in electric energy storage module 120, and the remainder flows to electrolyzer module 130. When the sun is not shining, the energy stored in electric energy storage module 120 then flows through electrolyzer module 130. As an example which neglects energy storage inefficiencies and provides a maximum capacity of electrolyzer module 130, assume that photovoltaic module 110 generates Ppv watts of power during h hours of operation per day. Further assume that electrolyzer module 130 is sized to have an input power Pe that consumes all of the power from photovoltaic module 110. This gives:

Pe=Ppv*h/24. Eq. 3

### In a practical system, there are inefficiencies due to energy storage, and electrolyzer module 130 with is slightly underutilized.

In another embodiment, electric energy storage module 120 is sized with sufficient capacity to permit electrolyzer module 130 to generate hydrogen for at least some predetermined number of days, without any additional solar flux impinging on photovoltaic module 110. Thus, for example, the capacity of electric energy storage module 120, in Eb joules, is equal to the maximum capacity of electrolyzer module 130 times the amount of time that the electric storage module runs the electrolyzer. Assuming that the efficiency with which energy is converted from stored energy to electric power is ηb, that the fraction of power that is available from the battery is D of the full charge, that electric energy storage module 130 is sized to operate for N days with no sun, and that electrolyzer module 130 is sized as previously calculated (Pe=Ppv*h/24), then:

Eb=Pe/(ηb*D)*N*24*60*60. Eq. 4

In yet another embodiment, solar hydrogen generation system 100 includes each of the above outlined design criteria, that is: photovoltaic module 110 is operated at or near Vmpp; the photovoltaic module and electric energy storage module 120 are sized such that electrolyzer module 130 generates hydrogen at an approximately constant rate; the electric energy storage module is sized with sufficient capacity to permit the electrolyzer module to generate hydrogen for at least some predetermined number of days N, such as N=1, 2, 3, 4, or 5 days, without any additional solar flux impinging on the photovoltaic module 110. Alternatively, system 100 includes a photovoltaic module that is mounted on a mechanism that tracks the sun, and the tracking is stopped if the SOC of the electric energy storage module indicates overcharging.

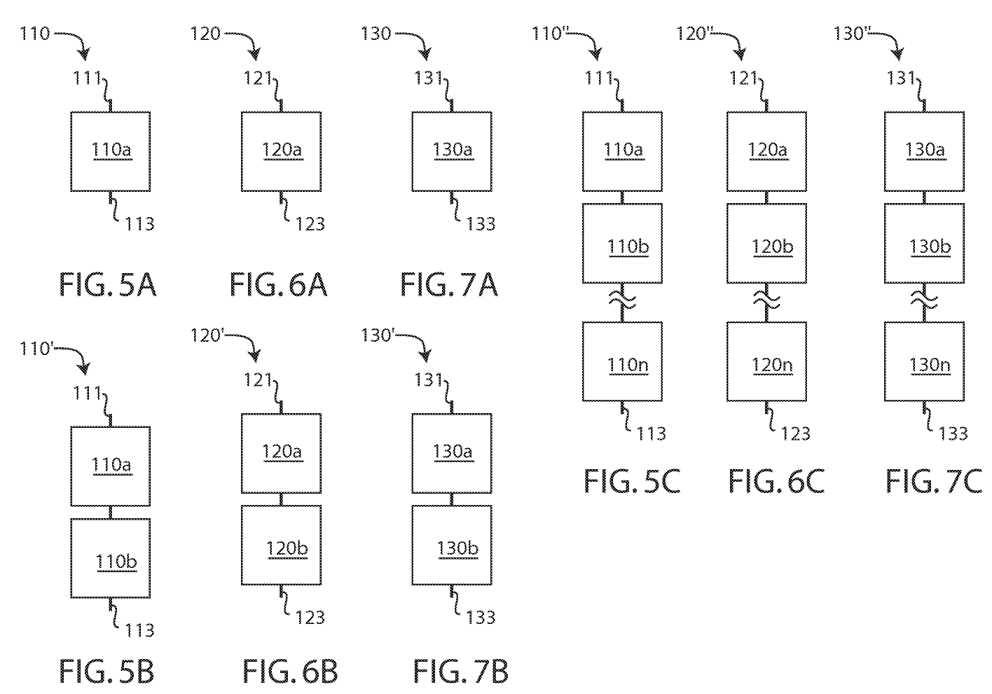

In one embodiment of the present invention, modules 110, 120, 130 are each composed from a number and arrangement of devices including, but not limited to, PV devices, rechargeable batteries, and electrolyzers, that allows system 100 to be advantageously operated at optimal or near optimal operating points for each module, without any further conditioning of the voltage within system 100. Series arrangements of the devices of module 110 are shown in FIGS. 5A, 5B, and 5C. FIG. 5A illustrates a photovoltaic module 110 having one photovoltaic device 110a, FIG. 5B illustrates a photovoltaic module 110 having two photovoltaic devices 110a and 110b in series. In general, photovoltaic module 110 may include a number “n” of photovoltaic devices in series, referred to as 110a, 110b, . . . , 110n in FIG. 5C. Similarly, the series arrangement of devices of electric energy storage module 120 is shown in FIGS. 6A, 6B, and 6C as including one device (120a), two devices (120a and 120b), or, in general “n” devices (120a, 120b, . . . , 120n). The series arrangement of devices of electrolyzer module 130 is shown in FIGS. 7A, 7B, and 7C as including one device (130a), two devices (130a and 130b), or, in general “n” devices (130a, 130b, . . . , 130n).

In general, each device in each module 110, 120, 130 can be different. For purposes of explaining the operation of system 100, it will henceforth be assumed, unless otherwise stated, that each device in each module 110, 120, 130 is the same. Thus, for example each device 110a, 110b, . . . , 110n is identical and are each referred to herein as a device 110x, each device 120a, 120b, . . . , 120n is identical and are each referred to herein as a device 120x, and each device 130a, 130b, . . . , 130n is identical and are each referred to herein as a device 130x. This limitation in no way limits the scope of the present invention, and it would be obvious, in light of the present disclosure, on how to generalize the invention to modules composed of a collection of different devices.

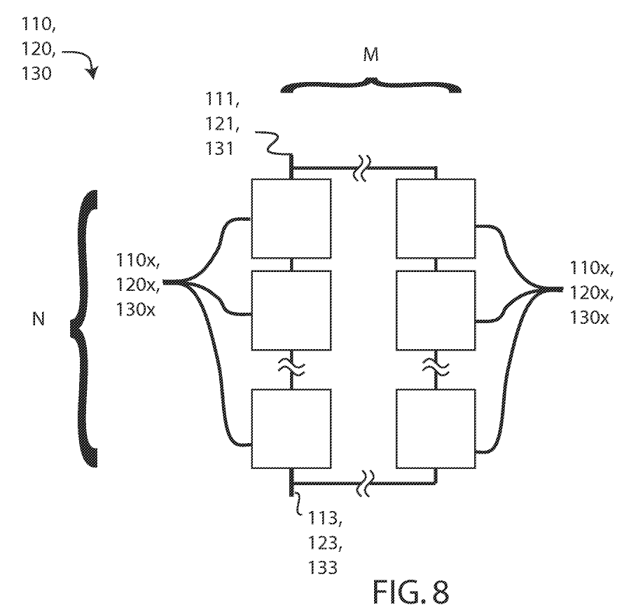

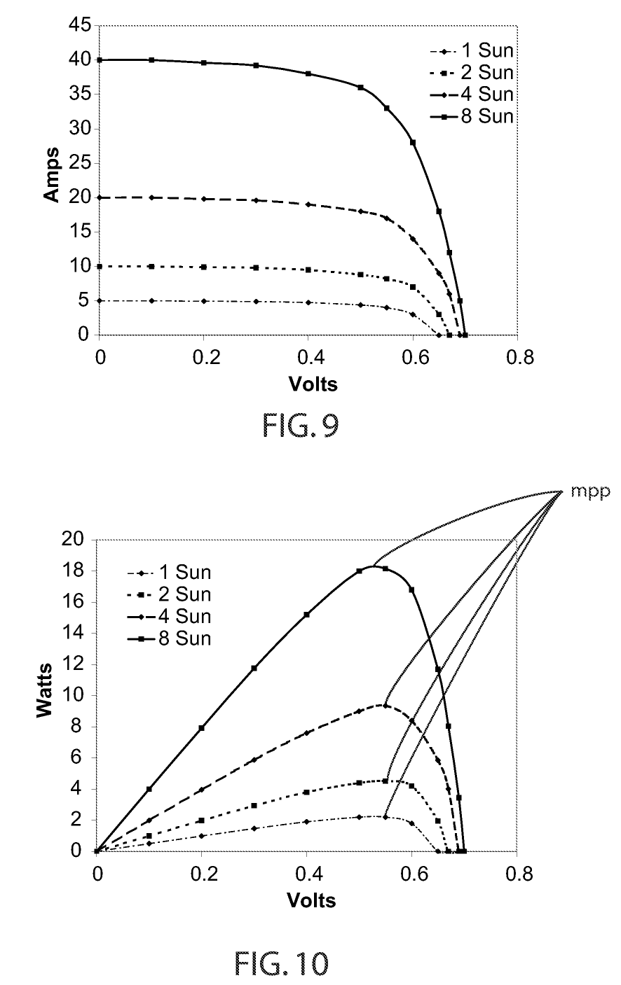

In another embodiment, one or more of module 110, 120, or 130 includes M groups of N devices, for a total of M×N devices. The devices are electrically connected to form M groups of N devices in series, and where there are M groups in parallel. FIG. 8 shows, without limitation, a schematic wiring diagram of one module 110, 120, or 130 of the present invention formed from m×n devices 110x, 120x, 130x, having pairs of terminals (111, 113), (121, 123), (131, 133), respectively. In general, the embodiment of FIG. 8 shows N devices 110x, 120x, 130x in series, with M of the N serially connected devices in parallel. Preferably, devices 110x, 120x, 130x have similar electrical characteristics. Arranging devices 110x, 120x, 130x as shown in FIG. 9 results in a voltage difference across module 110, 120, 130 that is N times the voltage across an individual device, and a total current that is M×N the current from an individual device.

Without limiting the scope of the claims, some specific operating characteristics of an embodiment system 100 are now presented. FIGS. 9 and 10 show characteristics for a silicon solar cell, which may be, for example, PV cell device 110x. Specifically, FIG. 9 shows an open circuit voltage-current plot and FIG. 10 shows the corresponding voltage-power plot for silicon solar. The output of a PV cell generally increases with the incident flux. This is indicated in FIGS. 9 and 10 at different amounts of solar concentration (or “suns”). As is shown in FIG. 10, there is one operating condition at each amount of solar concentration at which the power output is maximized. This maximum power point, or MMP, has a MMP voltage, Vmmp, and a corresponding MMP current, Immp, and is one preferred operating condition. In general, the voltage at MPP changes under different flux conditions. By concentrating the flux on PV module 110 the output increases, requiring fewer PV devices for the same power, and the number of PV devices in series can be chosen to optimize the PV performance under the desired concentration.

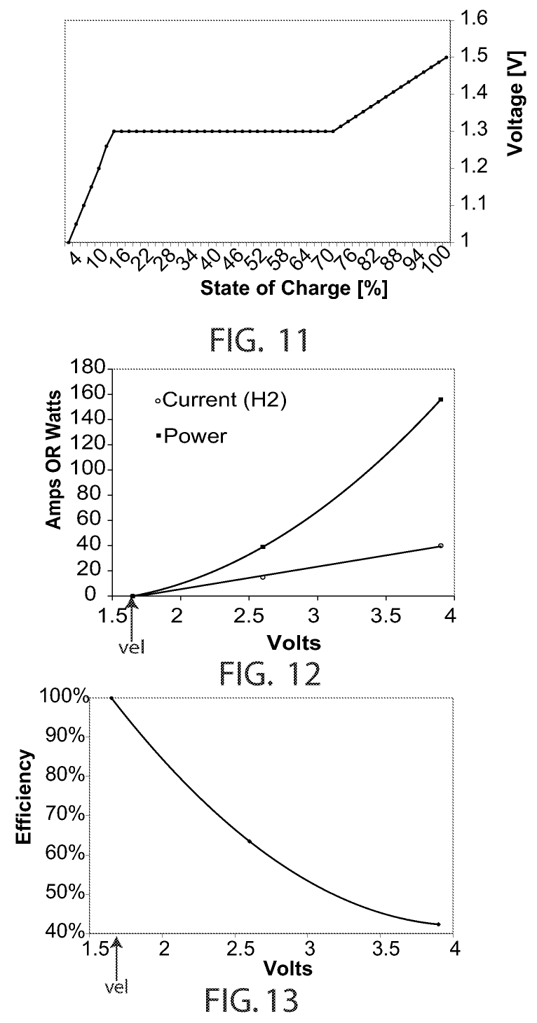

FIG. 11 shows characteristics for a rechargeable battery device 120x as the voltage-state of charge (SOC) for a NiFe battery. The acceptable amount of discharging depends on the type of battery, and must be maintained between limits to prevent overcharging or excessive discharging of the battery. In general, the SOC for individual rechargeable batteries must be maintained within the bounds 1≧SOC≧SOCmin, where SOCmin is battery dependent. Nickel-Iron batteries can be routinely discharged completely, and thus SOCmin=0 for a NiFe battery.

FIGS. 12 and 13 show typical characteristics for electrolyzer devices 130x, as the voltage-current and voltage-efficiency, respectively, of a single electrolyzer. The efficiency of an electrolyzer, as shown in FIG. 13, approximated by vel/ve, where vel the electric potential required to electrolyze the mixture across one electrolyzer cell. The efficiency of an electrolyzer is greatest when operated near the minimum voltage required for electrolysis, vel. It is thus advantageous to operate electrolyzers near ve=vel.

The arrangement of a number of devices in each of modules 110, 120, 130 permits the selection of the number of devices in each module to operate at approximately the same potential. Since devices 110x, 120x, 130x of modules 110, 120, 130 are connected in series, potential across pairs of terminals (111, 113), (121, 123), (131, 133) is the sum of the potential across the individual devices. Thus, for example, if photovoltaic module 110 has “r” devices 110x in series, each operating at the MPP, then the potential across terminals 111, 113 is Vpv≅r*vmpp, and the power generated by the photovoltaic module is Ppv=r*ppv.

If electric energy storage module 120 has “s” devices 120x in series, each with a potential difference vb and a capacity of eb joules, then the potential across terminals 121, 123 is Vb=s*vb, the capacity of the electric energy storage module is Eb=s*eb, and the SOC is given by the ratio of the actual amount of energy stored divided by the capacity. The actual amount of energy stored, in turn, depends on the past production of power by photovoltaic module 110 and use of power by electrolyze module 130. By measuring the potential across individual battery devices 120x, the SOC may be determined from known SOC-voltage relationships, as for example, in FIG. 11.

Further, if electrolyzer module 130 has “t” devices 130x in series, each with a potential difference ve and consuming pe of power to generate mh2 kilograms of hydrogen per second, then the potential across terminals 131, 133 is Ve=t*ve, and the electrolyzer module consumes Pe=t*pe of power to generate Mh2=t*mh2 of hydrogen.

Substituting the values from the previous three paragraphs into Equations 2, 3, and 4, and rearranging, gives:

r*vmpp≧s*vb≧t*ve; Eq. 5

pe/pvv=(r/t)*h/24; and Eq. 6

eb/(pe*60*60*24)=(t*N)/(s*ηb*D), Eq. 7

respectively. As one example of the use of Equations 5-7, consider system 100 formed from silicon solar cells, NiFe batteries, and KOH electrolyzers, and sized to store sufficient energy for three days of continuous operation without sun. For a silicon solar cell operating a 1 sun (unmagnified), vmpp=0.6 volts, the open circuit potential of a fully charged NiFe battery is approximately 1.3 volts, the amount of discharge is D=100%, the efficiency of NiFe batteries, ηb, is approximately 80%, and the potential required to electrolyze water in a KOH electrolyzer, ve, is approximately 1.8 volts. Equation 5 gives:

r*0.6≧s*1.3≧t*1.8; Eq. 9

Since r, s, and t are integers, Equation 8 may be written as:

s≧roundup(t*1.8/1.3) and Eq. 10

r≧roundup(s*1.3/0.6), Eq. 11

Some of the values of r, s, and t that satisfy Equations 10 and 11 are given, for example, in Table I below. In general, it is possible to more closely match the voltages across modules 110, 120, and 130 when there are a greater number of components in series.

TABLE 1
Number of devices 110x (individual silicon solar cells), 120x
(individual NiFe batteries), and 130x (individual KOH electrolyzer
cells) in series at one sun of magnification.

| Number of | Number | Number | | | |
|---|---|---|---|---|---|
| electrolyzer | of battery | of PV | | | |
| modules | modules | modules | Ve | Vb | Vpv |
| t | s | r | (volts) | (volts) | (volts) |
| 1 | 2 | 5 | 1.8 | 2.6 | 3.0 |
| 2 | 3 | 7 | 3.6 | 3.9 | 4.2 |
| 3 | 5 | 11 | 5.4 | 6.5 | 6.6 |
| 4 | 6 | 13 | 7.2 | 7.8 | 7.8 |
| 5 | 7 | 16 | 9.0 | 9.1 | 9.6 |
| 6 | 9 | 20 | 10.8 | 11.7 | 12.0 |
| 7 | 10 | 22 | 12.6 | 13.0 | 13.2 |
| 8 | 12 | 26 | 14.4 | 15.6 | 15.6 |
| 9 | 13 | 29 | 16.2 | 16.9 | 17.4 |
| 10 | 14 | 31 | 18.0 | 18.2 | 18.6 |

The number of devices indicated in Table I is the number that comes closest to matching the open circuit potential across each module, and does not represent the only possible, or even the best design choice. Thus, for example, embodiments that satisfy Equations 9, 10 and 11, for example, with larger values of r, s, or t result in a system having slightly overpowered modules, which may be desirable to ensure an adequate or steady hydrogen supply, or to overcome internal or other resistances of system 100. Thus, for example, one preferred embodiment has t=1, s=2, and r=7, giving Ve=1.8 volts, Vb=2.6 volts, and Vpv=4.2 volts, which supply slightly more power to the system than a system having t=1, s=2, and r=5. Other preferred embodiments are t=1, s=2, and r=5 or 6. Another preferred embodiment has t=2, s=3, and r=10, giving Ve=3.6 volts, Vb=3.9 volts, and Vpv=6.0 volts, which supply slightly more power to the system than a system having t=2, s=3, and r=7. Other preferred embodiments are t=2, s=3, and r=7, 8, or 9.

While a greater number of devices provides closer matching of voltages, in some circumstances, a fewer number of devices may be advantageous. Thus, for example, series components are limited by the lowest performing cell, and system interconnection (electrical, gas output) are fewer and potentially simpler with fewer devices in series (i.e. a 1 cell electrolyzer has good access to both electrodes for gas collection, a 2 cell electrolyzer has a somewhat more complicated manifold).

For the series-parallel arrangement illustrated in FIG. 8, the Equations 5-11 may be used to size the number of N devices 110x, 120x, 130x in series, and the total power produced or consumed by the respective module is given by the total number of devices.

The following is an example of one embodiment solar hydrogen generation system that has been designed for use in the San Francisco bay area, being oversized according to power output by 20% for typical summer conditions and undersized by 20% for typical winter conditions, with 4 hours per day sun average in the winter and 8 hours per day sun in the summer months. The electric energy storage module of this embodiment is sized to permit the generation of hydrogen throughout the night.

The solar hydrogen generation system has 30 square feet of PV and a hydrogen output of 5 scf/day. The system includes 21 solar cells (each forming one PV devices 110x) and arranged, with reference to FIG. 8, as a module 110 having M=3 parallel groups of N=7 serially connected cells. Each PV device is model A-300 mono crystalline silicon solar cell (Sunpower Corporation, Sunnyvale, Calif.). Each A-300 is nominally 125 mm square with a 20% efficiency. Each group of N=7 cells is arranged in an hexagonal arrangement (6 cells surrounding a central cell).

Each A-300 has a 14 inch diameter, 16 inch focal length Fresnel lens (Fresnel Technologies, Item 41) positioned 9 inches from the A-300, illuminating an area slightly larger than the A-300 with a flux of 7 suns (that is, the flux relative to the solar flux is magnified by a factor of 7). The output of each serially connected group of N=7 PV devices, magnified by the Fresnel lens, has a peak current of 40 A, and a typical output of 25 A at 3V, for a typical power of 75 W. The PV module are 3 parallel modules provide a typical output power of 225 W, 75 A at 3V. The PV module is mounted on a custom designed alt-azimuth tracking by Small Power Systems (Covelo, Calif.) having 200 ft² of available area.

The system has electric energy storage module 120 comprising 4 NiFe batteries (120x) arranged, with reference to FIG. 8, with M=2 and N=2. Each of the 4 devices 120x is a model TN400 (Sichuan Changhong Battery Company Limited, Mianyang Sichuan, China) rated at 420 AHrs at 1.2V. Module 120 of this embodiment is rated at 840 Amp hrs at 2.4 volts, and can thus store approximately 2000 W hr. It is estimated that during, module 120 charges at 50 A with a voltage of 3 V and discharges at 15 amps.

The system further has one electrolyzer 130x. The electrolyzer is a Hydrogen Wind, Inc. (Lineville, Iowa) standard KOH single cell water electrolyzer that, at the peak rating of 40 A at 4V produces ½ scf H2/hour. The system is designed to operate at 25 A at 3V during sunny conditions, and 15 A at 2.4V during dark conditions, throughout the night.

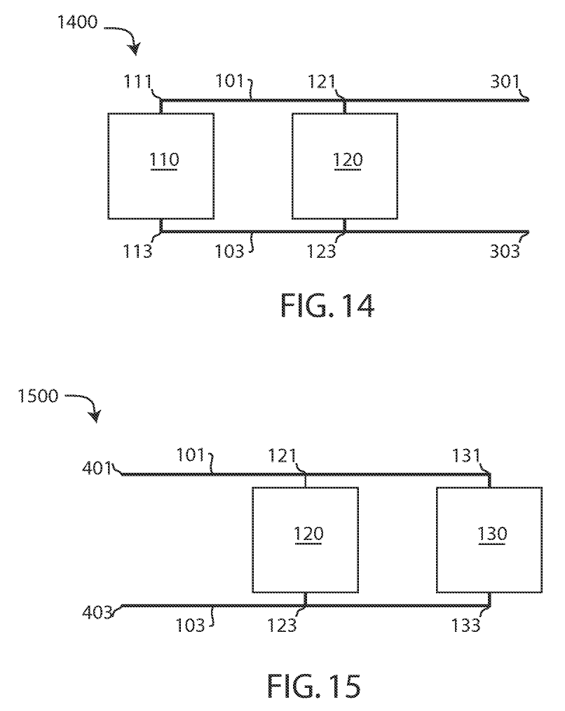

In addition to being assembled as a unit by combining modules 110, 120, and 130 into one system 100, the module may be arranged and packaged separately. Thus, for example, FIG. 14 is a schematic circuit diagram of a photovoltaic module/electric energy storage module combination 1400 that can be connected at terminals 301, 303 to an electrolyzer or electrolyzer module, or to another device to be run of solar energy. FIG. 15 is a schematic circuit diagram of an electric energy storage module/electrolyzer combination 1500 that can be powered, at terminals 401, 403 by a solar cell or by another power source such as a turbine or a windmill.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

I claim:

1. A solar energy device having electrical connections for powering an electrolyzer to electrolyze a water solution, said device comprising:
one or more photovoltaic cells; and
one or more batteries;
where said one or more photovoltaic cells and said one or more batteries are in parallel with the electrical connections for powering an electrolyzer.

2. The device of claim 1, where the maximum potential of said one or more photovoltaic cells is greater than the maximum potential of said one or more batteries.

3. The device of claim 2, where the maximum potential of said one or more batteries is greater than the minimum potential required to electrolyze the water solution.

4. The device of claim 1, where each of said one or more batteries is a nickel iron batteries.

5. The device of claim 1, where each of said one or more photovoltaic cells is a silicon solar cells.

6. The device of claim 1, where said one or more photovoltaic cells includes one or more photovoltaic cells in series.

7. The device of claim 6, where said one or more photovoltaic cells includes two or more groups of one or more photovoltaic cells in series.

8. The device of claim 1, where said one or more batteries includes one or more batteries in series.

9. The device of claim 8, where said one or more batteries includes two or more groups of one or more batteries in series.

10. A solar-powered electrolyzer to electrolyze a water solution, comprising:
one or more photovoltaic cells;
one or more batteries; and
one or more electrolyzers,
where said one or more photovoltaic cells and said one or more batteries are in parallel with said one or more electrolyzers.

11. The device of claim 10, where the maximum potential of said one or more photovoltaic cells is greater than the maximum potential of said one or more batteries.

12. The device of claim 11, where the maximum potential of said one or more batteries is greater than the minimum potential required to electrolyze the water solution.

13. The device of claim 10, where, when said one or more photovoltaic cells are exposed to a diurnal solar flux, said one or more photovoltaic cells and said one or more batteries have electrical characteristics to permit the continuous operation of said one or more electrolyzer cells.

14. The device of claim 13, where said electrical characteristics are selected to permit the continuous operation of said one or more electrolyzer cells when said one or more photovoltaic cells are exposed to no solar flux for up to four days.

15. The device of claim 11, where each of said one or more batteries is a nickel iron battery.

16. The device of claim 11, where each of said one or more photovoltaic cells is a silicon solar cells.

17. The device of claim 10, where said one or more photovoltaic cells includes one or more photovoltaic cells in series.

18. The device of claim 17, where said one or more photovoltaic cells includes two or more groups of one or more photovoltaic cells in series.

19. The device of claim 10, where said one or more batteries includes one or more batteries in series.

20. The device of claim 19, where said one or more batteries includes two or more groups of one or more batteries in series.

21. The device of claim 10, where said one or more electrolyzers includes one or more electrolyzers in series.

22. The device of claim 21, where said one or more electrolyzers includes two or more groups of one or more electrolyzers in series.

23. The device of claim 11, where said one or more batteries includes two nickel iron batteries in series, and where said one or more electrolyzers is one electrolyzer.

24. The device of claim 23, where said one or more photovoltaic cells includes five, six, or seven silicon solar cells in series.

25. The device of claim 11, where said one or more batteries includes three nickel iron batteries in series, and where said one or more electrolyzers is two electrolyzers in series.

26. The device of claim 25, where said one or more photovoltaic cells includes seven, eight, nine, or ten silicon solar cells in series.

27. The device of claim 11, where the number of said one or more photovoltaic cells is greater than the number of said one or more batteries.

28. The device of claim 11, where the number of said one or more batteries is greater than the number of said one or more electrolyzers.

29. A device for producing hydrogen from a flux of solar energy comprising:
one or more photovoltaic cells;
one or more batteries;
one or more electrolyzers electrically connected to said one or more photovoltaic cells and said one or more batteries; and
a mechanism for modifying the amount of solar energy impinging on said one or more photovoltaic cells.

30. The device of claim 29, where said mechanism prevents said one or more batteries from overcharging.

31. The device of claim 30, where said mechanism moves the orientation of said one or more photovoltaic cells relative to the horizon.
